(19) United States
(12) Patent Application Publication
(10) Pub. No.: US 2007/0138931 A1
(43) Pub. Date: Jun. 21, 2007

(54) Backwound electrode coil for electric arc tube of ceramic metal halide lamp and method of manufacture

(75) Inventor: Raghu Ramaiah, Euclid, OH (US)

Correspondence Address: PEARNE & GORDON LLP, 1801 EAST 9TH STREET, SUITE 1200, CLEVELAND, OH, 44114-3108, US

(73) Assignee: General Electric Company

(21) Appl. No.: 11/311,108

(22) Filed: Dec. 19, 2005

(51) Int. Cl. H01J 5/50; H01J 1/15; H01J 9/04

(52) U.S. Cl. 313/333; 313/341; 313/331; 445/32; 445/35; 445/48

(57) ABSTRACT

Tips for electrodes that are adapted to be applied to a ceramic halide lamp are formed by backwinding tungsten wire into a coil onto a tungsten shank. The outer diameter of the coil of tungsten wire is maintained sufficiently small so that the electrode tips can be inserted through openings in the legs of the electric arc tube of the ceramic halide lamp and the tungsten coil positioned within the hollow interior of the electric arc tube.

### BACKGROUND OF THE INVENTION

The present invention relates generally to electrodes for ceramic metal halide lamps. More specifically, the electrodes include tungsten tips that comprise backwound coils of tungsten wire wound onto tungsten shanks. Typically, the electrodes are supported within openings in projecting legs of electric arc tubes of the ceramic metal halide lamps and the outside diameters of the backwound coils of tungsten wire are of such a size that the electrodes can be inserted through the openings in the projecting legs into the interiors of the electric arc tubes.

A typical ceramic metal halide (“CMH”) lamp includes an electric arc tube and electrode assembly that is the source of the light provided by the CMH lamp. The electric arc tube includes an electric arc tube body that is made of a ceramic material, such as polycrystalline alumina for example, that can be transparent or translucent so as to allow for the passage of light. The electric arc tube body has a hollow interior and is closed at its opposed ends except for openings that are provided by respective projecting members, or legs, that are located at the closed ends of the electric arc tube body. In other words, each closed end of the electric arc tube has a respective projecting member or leg that is connected at one end to and projects axially away from that closed end and each projecting member or leg includes an opening that extends from the free end of the projecting member or leg through and along the interior of the projecting member or leg, through the closed end of the electric arc tube body and into the hollow interior of the tube body.

A respective electrode is supported within each opening in the legs, typically, so that one end of the electrode is located within the hollow interior of the electric arc tube body and the other end of the electrode is located adjacent the free end of the leg and provides a site for the electrode to be connected to an electric circuit that provides electrical current to the electrodes. Most often, the electrodes are held in place in the openings of the legs of the electric arc tube by a cermet. The end or tip of each electrode that is located within the hollow interior of the electric arc tube body can comprise a shank made of tungsten and a coil of tungsten wire mounted on the tungsten shank. The tips of the respective electrodes are aligned with and spaced from one another within the hollow interior of the electric arc tube body so that, at such time as the electric circuit to which the electrodes are connected is energized, an electric arc discharge is established between the tips of the respective electrodes.

A metal halide fill or dose is contained within the electric arc tube body together, typically, with mercury and a rare gas for starting the lamp. The electric arc tube body is contained within a transparent envelope that can be made of a material such as glass or quartz and that has been evacuated of gases or filled with a gas such as nitrogen for example. The electric arc discharge that is established between the tips of the respective electrodes provides the energy required for the ionization of the metal halide fill, thereby producing light that passes through the transparent or translucent electric arc tube body and the glass envelope and illuminates the area surrounding the CMH.

Conventionally, the openings in the legs or projecting members of the electric arc tube are narrow. For example, the openings in the legs can have a diameter of 1.6 mm. or less. Consequently, the electrodes, because they are incorporated into the electric arc tubes by insertion of the electrodes through the openings in the legs, must be of a size to allow for such insertion. In particular, the tips of the electrodes must be of a diameter that permits the tips to pass through the openings and be positioned within the hollow interior of the electric arc tube body.

It is common to use a coil of tungsten wire mounted on a tungsten shank as the tip of the electrode. The coil of tungsten wire is formed by first winding a single thickness or coil of a selected diameter of the wire on a molybdenum mandrel for an extended length. A plurality of coils is created by cutting into a number of units, such as with a diamond saw for example, the extended length of the molybdenum mandrel on which the tungsten wire has been wound. The cut units are then placed into an acid that is capable of dissolving the molybdenum mandrel but not the tungsten coils. After the molybdenum mandrel is dissolved and the tungsten coils are freed, the coils are placed onto tungsten shanks and the resulting assemblies of tungsten shanks and tungsten coils are used as the tips of the electrodes in the electric arc tubes. By forming the tungsten coils from a single layer or coil of tungsten wire, the outer diameter of the tungsten tip can be maintained such that the tungsten tip (shank and coil) can be inserted through the narrow openings in the legs of the electric arc tube.

The fabrication of the tungsten tips of the electrodes as described above can be problematic for at least two reasons. First, the cutting of the molybdenum mandrel on which the tungsten wire has been wound often produces sharp edges on the tungsten coils. As a result, during ignition of the CMH lamp, these sharp edges can constitute sites where very high electric fields are established and the electric arc discharge between the electrodes can be preferentially initiated at these sites. The sharp edges are not capable of dissipating as rapidly as desired the energy that exits at those edges and, consequently, the temperature of the edges can become excessive and result in rapid tungsten evaporation and the deposition of the evaporated tungsten on the interior walls of the electric arc tube body. The result of this condition is poor light maintenance. A second potential problem is that good contact between the tungsten shank and tungsten coil may not always be established when the tungsten coil is placed on the tungsten shank, resulting in inefficient operation of the CMH lamp.

### SUMMARY OF THE INVENTION

It has been determined that certain of the problems associated with the electrodes for electric arc tubes of CMH lamps and the assembling of the electrodes and tubes can be avoided, or at least substantially minimized, by forming the electrode tip by back-winding tungsten wire into a coil directly onto a tungsten shank. At the same time, the outside diameter of the tungsten coil can be maintained sufficiently small so that the electrode tip can be inserted through the openings in the legs of the electric arc tube and the tungsten coil positioned within the hollow interior of the electric arc body.

According to one aspect, a tungsten tip is provided that is adapted to comprise at least a portion of an electrode for a ceramic metal halide lamp. The tungsten tip comprises a tungsten shank having a forward end and a rearward end and a backwound coil of tungsten wire wound onto the tungsten shank adjacent the forward end of the tungsten shank.

According to another aspect, the backwound coil of tungsten wire comprises a bottom spiral of the tungsten wire in engagement with the tungsten shank and an upper spiral of the tungsten wire overlying and in engagement with the bottom spiral of the tungsten wire.

According to a further aspect, the bottom spiral of the tungsten wire is wound onto the tungsten shank in a direction from a location toward the rearward end of the tungsten shank to a location toward the forward end of the tungsten shank and the upper spiral of the tungsten wire is wound onto the bottom spiral of the tungsten wire in a direction from a location toward the forward end of the tungsten shank to a location toward the rearward end of the tungsten shank.

According to yet a further aspect, the tungsten tip is incorporated into an electrode that also includes an elongated member made of niobium and an elongated molybdenum mandrel about which a molybdenum coil of wire is wound. The elongated member made of niobium, the molybdenum mandrel and the tungsten tip are arranged end-to-end so that a first end of the molybdenum mandrel is secured to one end of the elongated member made of niobium and a second end of the molybdenum mandrel is secured to the rearward end of the tungsten shank.

In still another aspect, the tungsten tip forms a portion of an electrode of an electric arc tube and electrode assembly adapted to be applied to a ceramic metal halide lamp. The electric arc tube comprises an electric arc tube body made of a ceramic material that allows for the transmission of light therethrough. The electric arc tube body has a hollow interior and closed opposed ends. A respective projecting member has an attaching end that is attached to the closed opposed ends of the electric arc tube body and a free end. Each projecting member extends axially away from the hollow interior of the electric arc tube body from the attaching end of the projecting member to the free end of the projecting member. Additionally, each projecting member has an opening that extends from the free end of the projecting member through, and along the length of, the projecting member and through the attaching end of the projecting member and the closed opposed end of the electric arc tube body to which the attaching end of the projecting member is attached and into the hollow interior of the electric arc tube body. A respective electrode, at least a portion of which comprises the tungsten tip is disposed within the opening in each projecting member so that the tungsten coil is positioned within the hollow interior of the electric arc tube body.

In particular aspects, the outer diameter of the backwound tungsten coil of each tungsten tip is of a size such that the tungsten tip can pass through the opening of the projecting member in which the electrode, of which the tungsten tip comprises at least a portion, is disposed. In this connection, the outer diameter of the backwound tungsten coil can be less than about 1.6 mm.

According to an additional aspect, the tungsten wire, the tungsten shank of each tungsten tip and the opening in each projecting member are substantially circular in cross section and the ratio of the diameter of the tungsten shank to the diameter of the tungsten wire of each tungsten tip is equal to the diameter of the opening in the projecting member in which the tungsten tip is disposed multiplied by one and one-half plus one and four tenths. Further, the ratio of the weight of each tungsten coil to the diameter of the tungsten shank of each tungsten tip on which the tungsten coil is wound can be equal to the rated wattage of the ceramic metal halide lamp to which the electric arc tube and electrode assembly is adapted to be applied multiplied by one-tenth plus two and two-tenths. Also, the ratio of the surface area of each tungsten coil to the diameter of the tungsten shank of each tungsten tip on which the tungsten coil is wound can be equal to the current rating of the ceramic halide lamp to which the assembly is adapted to be applied multiplied by nine and six-tenths plus ten.

According to yet other aspects, the invention concerns methods for making the foregoing tungsten tips, electrodes and electric arc tube and electrode assemblies. Thus, according to one aspect, a method of making a tungsten tip adapted to comprise at least a portion of an electrode for a ceramic metal halide lamp comprises providing a tungsten shank having a forward end and a rearward end and forming a backwound tungsten wire coil on the tungsten shank adjacent the forward end of the tungsten shank while maintaining the outer diameter of the tungsten wire coil at less than about 1.6 mm. The backwound tungsten wire coil can be formed by winding tungsten wire around the tungsten shank so as to form a bottom spiral of the tungsten wire coil in engagement with the tungsten shank and winding tungsten wire around the bottom spiral of the tungsten wire coil so as to form an upper spiral of the tungsten wire coil overlying and in engagement with the bottom spiral of the tungsten wire coil. Further, the bottom spiral of the tungsten wire coil can be wound onto the tungsten shank in a direction from a location toward the rearward end of the tungsten shank to a location toward the forward end of the tungsten shank and the upper spiral of the tungsten wire coil can be wound onto the bottom spiral of the tungsten wire coil in a direction from a location toward the forward end of the tungsten shank to a location toward the rearward end of the tungsten shank

According to another aspect, a method of making an electrode for a ceramic metal halide lamp comprises providing a tungsten tip in the manner described above, securing the rearward end of the tungsten shank to one end of an elongated molybdenum mandrel about which a molybdenum coil of wire has been wound and securing the other end of the molybdenum mandrel to one end of an elongated member made of niobium.

According to still another aspect, electric arc tubes and electrodes having tungsten tips as described above are provided and the tungsten tips of the electrodes are inserted into the openings of the projecting members until the tungsten wire coil of the tungsten tips are positioned within the hollow interior of the electric arc body. The outer diameter of the tungsten wire coils can be about equal to or less than the size of the openings in the projecting members.

### BRIEF DESCRIPTION OF THE DRAWING

FIG. 1 is a perspective view of an embodiment of an electric arc tube and electrode assembly of the invention shown in section along the longitudinal extent of the assembly.

FIG. 2 is an elevational view of an embodiment of an electrode of the invention.

FIG. 3 is an enlarged somewhat schematic representation of an embodiment of a tungsten tip of the invention.

Where the same reference numeral is used in more than one figure of the drawing, the reference numeral refers to the same element in each figure.

### DESCRIPTION OF AN EMBODIMENT OF THE INVENTION

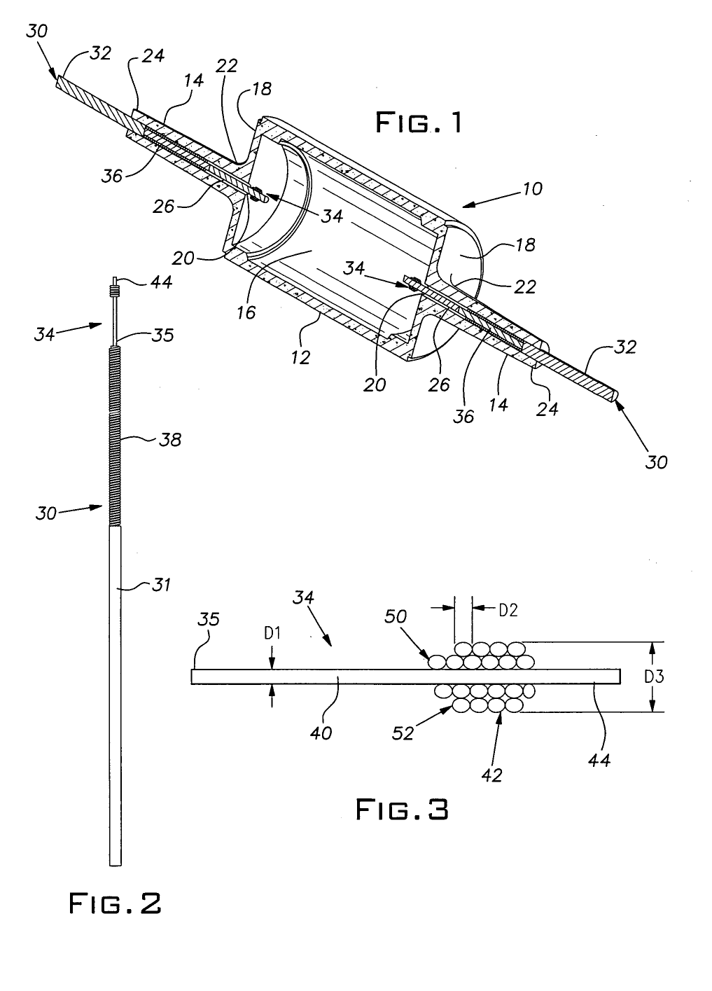

Referring first to FIG. 1 of the drawing, there is shown an embodiment of an electric arc tube and electrode assembly, indicated generally at 10 that is adapted to be applied to a CMH lamp. The electric arc tube comprises a substantially cylindrical electric arc tube body 12 with projecting members, or legs, 14 and electrodes indicated generally at 30. The electric arc tube body 12 has a hollow interior 16, that, in the embodiment of the invention shown in FIG. 1, is substantially cylindrical in shape and two opposed closed ends 18. Although the form of the exterior of the electric arc body and the form of the hollow interior of the electric arc body are shown to be substantially cylindrical in the embodiment of the invention illustrated in FIG. 1, they can have different forms. For example, they can have an oblate form.

The electric arc tube can be made of any of a number of ceramic materials such as, for example, polycrystalline alumina or YAG (a composite of yttrium, alumina and garnet). The ceramic material is transparent or translucent and allows for the transmission of light therethrough from the hollow interior 16 of the electric arc tube body to the exterior of the body. In this connection, the CMH lamp to which the assembly 10 is adapted to be applied includes a transparent glass envelope, not shown, that encloses the electric arc tube in a manner that will be familiar to those having ordinary skill in the art.

The ends 18 of the electric arc tube body are closed except for the openings 20 that are provided in the legs 14. Thus, as can be seen in FIG. 1 of the drawing, each closed end 18 of the electric arc tube has a respective projecting member or leg 14 that is attached at an attaching end 22 to that closed end 18 and a free end 24. Each projecting member 14 extends axially away from the hollow interior 16 of the electric arc tube body 12 to the free end 24 of the projecting member. Each leg 14 includes an opening 26 that extends from the free end 24 of the leg through, and along the length of, the leg and through the attaching end 22 of the leg 14 and a closed opposed end 18 of the electric arc tube body to which the attaching end 22 of the leg 14 is attached and into the hollow interior 16 of the electric arc tube body 12.

A respective electrode, indicated generally at 30 in FIGS. 1 and 2 of the drawing, at least a portion of which comprises a tungsten tip as described below, is disposed within the opening 26 in each leg 14. The electrodes are held in place by means of a cermet that is placed in the space between the exterior of the electrodes 30 and the walls of the openings 26 in a manner familiar to those skilled in the art. One end 32 of each electrode 30 extends beyond the free end 24 of the leg 14 in which the electrode is located, and the other end, or tip, indicated generally at 34, extends into the hollow interior 16 of the electric arc tube body 12. As will be understood by those skilled in the art, when the assembly 10 is in place within the light-transmitting envelope of a CMH lamp, the ends 32 of the electrodes 30 are connected to an electric circuit that provides electric current to the electrodes. More specifically, typically, a metal base, not shown, closes off one end of the envelope that surrounds the electric arc tube and, through the use of appropriate conductive elements, an electric circuit is established that allows electric energy from a source of electric energy to be delivered to the electrodes through the metal base of the CMH lamp.

Typically, a metal halide fill or dose is contained within the electric tube body 12 together with mercury and a rare gas for starting the lamp. As indicated in FIG. 1, the tips 34 of the electrodes 30 are axially aligned with and spaced from one another within the hollow interior 16 of the electric arc tube body 12. As a result, when the electric circuit to which the CMH lamp is conductively connected is energized, an electric arc discharge is established between the tips 34 of the electrodes 30. The discharge provides the energy that is required for the ionization of the metal halide fill, thereby producing light that passes through the transparent or translucent electric arc tube body 12 and the envelope surrounding the electric arc tube body and illuminates the area in the vicinity of the CMH lamp.

Referring both to FIGS. 1 and 2 for a further description of the electrodes 30 of the embodiment of the invention shown in the drawing, it can be seen that the electrodes comprise an elongated member 31 made of niobium, an elongated molybdenum mandrel 36 about which a molybdenum coil of wire 38 is wound and the tungsten tip 34. These components that comprise the electrodes are arranged end-to-end as shown in FIGS. 1 and 2 so that a first end of the molybdenum mandrel 36 is secured to one end of the elongated member 31 made of niobium and a second end of the molybdenum mandrel 36 is secured to the rearward end 35 of the tungsten tip 34. The components can be secured to one another by the use of TIG (tungsten-inert gas) welding in a manner familiar to those of ordinary skill in the art.

An enlarged view of the tungsten tip 34 of each electrode 30 is shown in FIG. 3 and reference is had thereto for a further description of the tungsten tips. It is first noted that the tungsten tips that are adapted to comprise at least the portion of an electrode for a ceramic metal CMH lamp comprise a tungsten shank 40 and a backwound coil 42 of tungsten wire attached to the shank. The tungsten shank 40 has a forward end 44 in addition to the rearward end 35. The backwound coil 42 of tungsten wire comprises a bottom spiral 50 of the tungsten wire in engagement with the tungsten shank 40 and an upper spiral 52 of the tungsten wire overlying and in engagement with the bottom spiral 50 of the tungsten wire.

In the embodiment of the invention shown in the drawing, the bottom spiral 50 of the tungsten wire is wound onto the tungsten shank 40 in a direction from a location toward the rearward end 35 of the tungsten shank to a location toward the forward end 44 of the tungsten shank, in other words, from left to right as viewed in FIG. 3. When the bottom spiral 50 has been completed, the upper spiral 52 of the tungsten wire is wound onto the bottom spiral of the tungsten wire 50 in a direction from a location toward the forward end of the tungsten shank to a location toward the rearward end of the tungsten shank, in other words, from right to left as viewed in FIG. 3. Because the upper spiral 52 of the tungsten wire coil is formed by winding the tungsten wire back over the bottom spiral 50 of the coil in a direction opposite to the direction in which the bottom spiral of the wire is wound onto the tungsten shank, the tungsten coil is said to comprise a “backwound” coil. Any known method of winding tungsten wire into a coil around a tungsten shank as are known to those skilled in the art in the connection with the manufacture of lamps other than CMH lamps, such as high pressure sodium and quartz metal halide lamps, can be used.

The openings in the legs of the electric arc tube in typical CMH lamps are smaller, or narrower, than similar openings in other types of arc lamps such as high pressure sodium and quartz metal halide lamps. The openings in CMH lamps can be as narrow as 1.6 mm. or less. Consequently, in order to assemble an electric arc tube and electrodes by inserting the electrodes through the openings in the legs as described above, the outer diameter of the backwound tungsten coil, dimension D3 in FIG. 3, must be correspondingly small.

A tungsten electrode tip wherein the tungsten coil is of a satisfactory size can be produced by providing an electrode tip whose characteristics, together with certain characteristics of the legs of the electric arc tube and the CMH lamp itself, satisfy the following formulas:
D1/D2=(1.5)(Leg I.D.)+1.4 (1)
Coil Mass/D1=(0.1)(Lw)+2.2 (2)
Coil Area/D1=(9.6)(Li)+10 (3)

The elements of the foregoing formulas have the following meanings:

D1 is the diameter of the tungsten shank as indicated in FIG. 3;

D2 is the diameter of the tungsten wire as indicated in FIG. 3;

Leg I.D. is the diameter of the openings 26 in the legs 14 of the electric arc tube 10;

Coil Mass is the weight of the tungsten coil 42;

Lw is the rated wattage of the CMH lamp;

Coil Area is the total outside surface area of the tungsten coil 42; and

Li is the current rating of the CMH lamp.

As will be understood by those having ordinary skill in the art, formula (1) above may be read as providing that the ratio of the diameter of the tungsten shank to the diameter of the tungsten wire of the tungsten tip is equal to the diameter of the opening in the projecting member in which the tungsten tip is disposed multiplied by one and one-half plus one and four-tenths; formula (2) may be read as providing that the ratio of the weight of the tungsten coil to the diameter of the tungsten shank of the tungsten tip is equal to the rated wattage of the CMH lamp to which the electric arc tube and electrode assembly is adapted to be applied multiplied by one-tenth plus two and two-tenths; and formula (3) above may be read as providing that the ratio of the surface area of the tungsten coil to the diameter of the tungsten shank of the tungsten tip is equal to the current rating of the CMH lamp to which the electric arc tube and electrode assembly is adapted to be applied multiplied by nine and six-tenths plus ten.

Formulas (1), (2) and (3) above, which have been derived using regression analysis, specifically relate to the application of the backwound coils of the invention to CMH lamps. Additionally, the units used in the derivation of the formulas are millimeters for linear and areal dimensions, watts for wattage ratings and amperes for current ratings.

Although the invention has been described with reference to an embodiment wherein the electrode includes a tungsten tip 34, an intermediate molybdenum mandrel 36 and coil 38 and an elongated niobium member 31, other electrode structures may be used so long as the electrode structures include a backwound tungsten coil as described above.

It will be understood from the foregoing description that the present invention also provides a method of making a tungsten tip that is adapted to comprise at least a portion of an electrode for a CMH lamp. The method comprises providing a tungsten shank 40 having a forward end 44 and a rearward end 35 and forming a backwound tungsten wire coil 42 on the tungsten shank adjacent the forward end of the tungsten shank while maintaining the outer diameter of the tungsten wire coil at less than about 1.6 mm. The tungsten wire coil can be formed by winding tungsten wire around the tungsten shank so as to form a bottom spiral 50 of the tungsten wire coil in engagement with the tungsten shank and winding tungsten wire around the bottom spiral of the tungsten wire coil so as to form an upper spiral 52 of the tungsten wire coil overlying and in engagement with the bottom spiral of the tungsten wire coil. The method additionally can comprise winding the bottom spiral of the tungsten wire coil onto the tungsten shank in a direction from a location toward the rearward end 35 of the tungsten shank 40 to a location toward the forward end 44 of the tungsten shank, and winding the upper spiral of the tungsten wire coil onto the bottom coil of the tungsten wire coil in a direction from a location toward the forward end of the tungsten shank to a location toward the rear ward end of the tungsten shank.

Additionally, the invention provides a method of making an electrode for a CMH lamp wherein the rearward end of the tungsten shanks of the tungsten tips made as described in paragraph [0037] can be secured to one end of an elongated molybdenum mandrel 36 about which a molybdenum coil of wire 38 has been wound and the other end of the molybdenum mandrel secured to one end of an elongated member 31 made of niobium.

Further, the invention provides a method of making an electric arc tube and electrode assembly 10 adapted to be applied to a CMH lamp wherein the electrode tips and electrodes that are incorporated into the assembly are made as described in paragraphs [0036] and [0037] above. The assembly can be made by providing an electric arc tube comprising an electric arc tube body 12 made of a ceramic material that allows for the transmission of light therethrough, the electric arc tube body having a hollow interior 16 and closed opposed ends 18 and a respective projecting member 14 having an attaching end 22 that is attached to the closed opposed ends of the electric arc tube body and a free end 24. Each projecting member 14 extends axially away from the hollow interior 16 of the electric arc tube body 12 from the attaching end 22 of the projecting member to the free end 24 of the projecting member, and each projecting member has an opening 26 extending from the free end 24 of the projecting member through, and along the length of, the projecting member and through the attaching end 22 of the projecting member and the closed opposed end 18 of the electric arc tube body 12 to which the attaching end of the projecting member is attached and into the hollow interior 16 of the electric arc tube body. Electrode tips of electrodes as described in paragraphs [0037] and [0038] are inserted into the opening 26 of a projecting member 14 until the tungsten wire coil 42 is positioned within the hollow interior 16 of the electric arc body 12. The outer diameter D3 of the tungsten wire coil 42 of the tungsten tip 34 can be about equal to or less than the size of the opening 26 in the projecting member 14 in which the tungsten tip is inserted.

The method of the invention also can provide for maintaining the characteristics of the electrode tip 34 (including the tungsten wire coil 42), the openings 26 in the projecting members 14 and the CMH lamp itself such that formulas (1), (2) and (3) above are satisfied.

Although the invention has been described with respect to a specific embodiment, it will be recognized by those skilled in the art that the invention can be practiced with modifications that are within the spirit and the scope of the claims that follow.

What is claimed is:

1. A tungsten tip adapted to comprise at least a portion of an electrode for a ceramic metal halide lamp, the tungsten tip comprising:
a tungsten shank having a forward end and a rearward end; and
a backwound coil of tungsten wire wound onto the tungsten shank adjacent the forward end of the tungsten shank.

2. The tungsten tip of claim 1 wherein:
the outer diameter of the backwound tungsten coil is less than about 1.6 mm.

3. The tungsten tip of claim 1 wherein the backwound coil of tungsten wire comprises:
a bottom spiral of the tungsten wire in engagement with the tungsten shank; and
an upper spiral of the tungsten wire overlying and in engagement with the bottom spiral of the tungsten wire.

4. The tungsten tip of claim 3 wherein:
the bottom spiral of the tungsten wire is wound onto the tungsten shank in a direction from a location toward the rearward end of the tungsten shank to a location toward the forward end of the tungsten shank; and
the upper spiral of the tungsten wire is wound onto the bottom spiral of the tungsten wire in a direction from a location toward the forward end of the tungsten shank to a location toward the rearward end of the tungsten shank.

5. The tungsten tip of claim 4 wherein;
the outer diameter of the backwound tungsten coil is less than about 1.6 mm.

6. An electrode for a ceramic metal halide lamp comprising:
an elongated member made of niobium;
an elongated molybdenum mandrel about which a molybdenum coil of wire is wound; and
a tungsten tip comprising a tungsten shank having a forward end and a rearward end and a backwound coil of tungsten wire wound onto the tungsten shank adjacent the forward end of the tungsten shank;
the elongated member made of niobium, the molybdenum mandrel and the tungsten tip being arranged end-to-end so that a first end of the molybdenum mandrel is secured to one end of the elongated member made of niobium and a second end of the molybdenum mandrel is secured to the rearward end of the tungsten shank.

7. The electrode of claim 6 wherein;
the outer diameter of the backwound tungsten coil is less than about 1.6 mm.

8. An electric arc tube and electrode assembly adapted to be applied to a ceramic metal halide lamp comprising:
an electric arc tube comprising an electric arc tube body made of a ceramic material that allows for the transmission of light therethrough, the electric arc tube body having a hollow interior and closed opposed ends, and a respective projecting member having an attaching end that is attached to the closed opposed ends of the electric arc tube body and a free end, each projecting member extending axially away from the hollow interior of the electric arc tube body from the attaching end of the projecting member to the free end of the projecting member, and each projecting member having an opening extending from the free end of the projecting member through, and along the length of, the projecting member and through the attaching end of the projecting member and the closed opposed end of the electric arc tube body to which the attaching end of the projecting member is attached and into the hollow interior of the electric arc tube body; and
a respective electrode, at least a portion of which comprises a tungsten tip, disposed within the opening in each projecting member, the tungsten tip of each respective electrode comprising a tungsten shank having a forward end and a rearward end and a backwound tungsten coil wound onto the tungsten shank adjacent the forward end of the tungsten shank, the electrode being disposed within the opening in the projecting member so that the tungsten coil is positioned within the hollow interior of the electric arc tube body.

9. The electric arc tube and electrode assembly of claim 8 wherein the outer diameter of the backwound tungsten coil of each tungsten tip is of a size such that the tungsten tip can pass through the opening of the projecting member in which the electrode, of which the tungsten tip comprises at least a portion, is disposed.

10. The electric arc tube and electrode assembly of claim 9 wherein;
the outer diameter of the backwound tungsten coil is less than about 1.6 mm.

11. The electric arc tube and electrode assembly of claim 9 wherein each backwound coil of tungsten wire comprises:
a bottom spiral of the tungsten wire in engagement with the tungsten shank; and
an upper spiral of the tungsten wire overlying and in engagement with the bottom spiral of the tungsten wire.

12. The electric arc tube and electrode assembly of claim 11 wherein:
the bottom spiral of the tungsten wire of each tungsten coil is wound onto a respective tungsten shank in a direction from a location toward the rearward end of the tungsten shank to a location toward the forward end of the shank; and
the upper spiral of the tungsten wire of the tungsten coil is wound onto the bottom spiral of the tungsten wire in a direction from a location toward the forward end of the tungsten shank to a location toward the rearward end of the tungsten shank.

13. The electric arc tube and electrode assembly of claim 12 wherein:
the tungsten wire, the tungsten shank of each tungsten tip and the opening in each projecting member are substantially circular in cross section and the ratio of the diameter of the tungsten shank to the diameter of the tungsten wire of each tungsten tip is equal to the diameter of the opening in the projecting member in which the tungsten tip is disposed multiplied by one and one-half plus one and four tenths.

14. The electric arc tube and electrode assembly of claim 13 wherein:
the ratio of the weight of each tungsten coil to the diameter of the tungsten shank of each tungsten tip on which the tungsten coil is wound is equal to the rated wattage of the ceramic metal halide lamp to which the assembly is adapted to be applied multiplied by one-tenth plus two and two-tenths.

15. The electric arc tube and electrode assembly of claim 14 wherein:
the ratio of the surface area of the tungsten coil to the diameter of the tungsten shank of each tungsten tip is equal to the current rating of the ceramic halide lamp to which the assembly is adapted to be applied multiplied by nine and six-tenths plus ten.

16. The electric arc tube and electrode assembly of claim 10 wherein each respective electrode in addition to the tungsten tip comprises:
an elongated member made of niobium; and
an elongated molybdenum mandrel about which a molybdenum coil of wire is wound;
and the elongated member made of niobium, the molybdenum mandrel and the tungsten tip are arranged end-to-end so that a first end of the molybdenum mandrel is secured to one end of the elongated member made of niobium and a second end of the molybdenum mandrel is secured to the rearward end of the tungsten shank.

17. A method of making a tungsten tip adapted to comprise at least a portion of an electrode for a ceramic metal halide lamp comprising:
providing a tungsten shank having a forward end and a rearward end; and
forming a backwound tungsten wire coil on the tungsten shank adjacent the forward end of the tungsten shank while maintaining the outer diameter of the tungsten wire coil at less than about 1.6 mm.

18. The method of claim 17 wherein the backwound tungsten wire coil is formed by;
winding tungsten wire around the tungsten shank so as to form a bottom spiral of the tungsten wire coil in engagement with the tungsten shank; and
winding tungsten wire around the bottom spiral of the tungsten wire coil so as to form an upper spiral of the tungsten wire coil overlying and in engagement with the bottom spiral of the tungsten wire coil.

19. The method of claim 18 comprising:
winding the bottom spiral of the tungsten wire coil onto the tungsten shank in a direction from a location toward the rearward end of the tungsten shank to a location toward the forward end of the tungsten shank; and
winding the upper spiral of the tungsten wire coil onto the bottom spiral of the tungsten wire coil in a direction from a location toward the forward end of the tungsten shank to a location toward the rearward end of the tungsten shank.

20. A method of making an electrode for a ceramic metal halide lamp comprising:
providing a tungsten shank having a forward end and a rearward end;
forming a backwound tungsten wire coil on the tungsten shank adjacent the forward end of the tungsten shank while maintaining the outer diameter of the tungsten wire coil at less than about 1.6 mm;
securing the rearward end of the tungsten shank to one end of an elongated molybdenum mandrel about which a molybdenum coil of wire has been wound; and
securing the other end of the molybdenum mandrel to one end of an elongated member made of niobium.

21. A method of making an electric arc tube and electrode assembly adapted to be applied to a ceramic metal halide lamp comprising:
providing an electric arc tube comprising an electric arc tube body made of a ceramic material that allows for the transmission of light therethrough, the electric arc tube body having a hollow interior and closed opposed ends, and a respective projecting member having an attaching end that is attached to the closed opposed ends of the electric arc tube body and a free end, each projecting member extending axially away from the hollow interior of the electric arc tube body from the attaching end of the projecting member to the free end of the projecting member, and each projecting member having an opening extending from the free end of the projecting member through, and along the length of, the projecting member and through the attaching end of the projecting member and the closed opposed end of the electric arc tube body to which the attaching end of the projecting member is attached and into the hollow interior of the electric arc tube body;
making electrodes having tungsten tips that comprise at least a portion of the electrodes by providing tungsten shanks having forward ends and rearward ends and forming a backwound tungsten wire coil on each tungsten shank adjacent the forward end of the tungsten shank; and
inserting the tungsten tip of a respective electrode into the opening of a projecting member until the tungsten wire coil of the tungsten tip is positioned within the hollow interior of the electric arc body.

22. The method of claim 21 wherein:
the outer diameter of each tungsten wire coil of each tungsten tip is about equal to or less than the size of the opening in the projecting member in which the tungsten tip is inserted.

23. The method of claim 22 wherein the backwound tungsten wire coil is formed by;
winding tungsten wire around the tungsten shank so as to form a bottom spiral of the tungsten wire coil in engagement with the tungsten shank; and
winding tungsten wire around the bottom spiral of the tungsten wire coil so as to form an upper spiral of the tungsten wire coil overlying and in engagement with the bottom spiral of the tungsten wire coil.

24. The method of claim 23 comprising:
winding the bottom spiral of the tungsten wire coil onto the tungsten shank in a direction from a location toward the rearward end of the tungsten shank to a location toward the forward end of the tungsten shank; and
winding the upper spiral of the tungsten wire coil onto the bottom spiral of the tungsten wire coil in a direction from a location toward the forward end of the tungsten shank to a location toward the rearward end of the tungsten shank.

25. The method of claim 24 wherein:
the tungsten wire, the tungsten shank of each tungsten tip and the opening in each projecting member are substantially circular in cross section and the ratio of the diameter of the tungsten shank to the diameter of the tungsten wire of each tungsten tip is equal to the diameter of the opening in the projecting member in which the tungsten tip is disposed multiplied by one and one-half plus one and four tenths.

26. The electric arc tube and electrode assembly of claim 25 wherein:
the ratio of the weight of each tungsten coil to the diameter of the tungsten shank of each tungsten tip on which the tungsten coil is wound is equal to the rated wattage of the ceramic metal halide lamp to which the assembly is adapted to be applied multiplied by one-tenth plus two and two-tenths.

27. The electric arc tube and electrode assembly of claim 26 wherein:
the ratio of the surface area of each tungsten coil to the diameter of the tungsten shank of each tungsten tip on which the tungsten coil is wound is equal to the current rating of the ceramic halide lamp to which the assembly is adapted to be applied multiplied by nine and six-tenths plus ten.
